(19) United States
(12) Patent Application Publication
(10) Pub. No.: US 2005/0256837 A1
(43) Pub. Date: Nov. 17, 2005

(54) Information providing device and information providing program

(75) Inventor: Tomoki Kira, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/951,595

(22) Filed: Sep. 29, 2004

(30) Foreign Application Priority Data
May 17, 2004 (JP) 2004-146312

(51) Int. Cl. G06F 7/00

(52) U.S. Cl. 707/1

(57) ABSTRACT

An information providing device capable of providing information through Web pages so that a user (a browsing party of the Web page) can acquire a desired piece of information without performing intricate operations. The information providing devices has such architecture that if a certain link anchor is manipulated (clicked) on the computer of the user who desires to acquire the information, the user can be provided with the information by displaying the standard content page that is to be redisplayed when there is met the predetermined condition about the elapse time since a point of time when the anchor manipulation has been done.

### BACKGROUND OF THE INVENTION

1. Field of the Invention

The present invention relates to an information providing device for providing pieces of information through Web pages, and further to an information providing program for instructing a computer to function as the information providing device.

2. Description of the Related Art

As known well, among Websites on which information having a comparatively large data size about a specified theme is opened to the public via the Internet, there is a Website (refer to, e.g., Japanese Patent Application Laid-Open Publication No. 2003-168052) on which the information is opened to the public through a group of Web pages that can not be utilized (browsed) only in a predetermined sequence. On such a general type of Website, the information is opened to the public through the Web page group containing link anchors (which will hereinafter be called page scroll link anchors) for displaying a next page and a previous page. This general type of Website provides users with the information through the Web pages containing, in addition to the page scroll link anchors, link anchors linked to Web pages that can not be displayed by manipulations for the page scroll link anchors.

Therefore, on this Website, it often happens that the user who tries to acquire a certain piece of information might get into difficulty of redisplaying an originally-displayed Web page during the manipulation (clicking) of the link anchors (wherein the screen does not return to the originally-displayed Web page unless a “return” button on the Web Browser is pressed multiple times, or the originally-displayed Web page can not be redisplayed by pressing the “return” button on the Web Browser). It may be said that there are none of the users who will click the link anchors after reading all the information shown on a certain Web page. Therefore, on the Website where the information is opened to the public through the Web page containing the page scroll link anchors, a desired piece of information can not be after all acquired unless the user performs intricate operations.

A normal Web page (containing none of the page scroll link anchors) provided to the public on the conventional Website also has the difficulty with which the originally-displayed Web page is redisplayed while clicking the link anchors. Hence, on the Website where the information is opened to the public through the normal Web page, the desired piece of information can not be acquired unless the user performs the complicated operations.

### SUMMARY OF THE INVENTION

It is an object of the present invention to provide an information providing device capable of providing information through Web pages so that a user (a browsing party of the Web page) can acquire a desired piece of information without performing intricate operations, and an information providing program capable of instructing a computer to function as this information providing device.

To accomplish the above object, an information providing device according to a first mode of the present invention includes a source file storage unit stored with a variety of source files related to various categories of Web pages, and a Web page providing unit enabling a computer capable of Web-browsing to display a standard content page containing some link anchors linked to non-standard content pages or to display a non-standard content page containing some link anchors linked to other non-standard content pages by use of the source file stored on the source file storage unit, and instructing the computer having displayed the standard content page to execute a process of redisplaying the standard content page when meeting a predetermined condition concerning an elapse time since a certain link anchor on the standard content page has been manipulated (clicked).

An information providing device according to a second mode of the present invention includes a source file storage unit stored with a variety of source files related to various categories of Web pages, and a tour page providing unit for instructing a computer capable of Web-browsing to display various categories of tour pages in each of which a guide page containing link anchors linked to other tour pages is displayed in a guide frame, and a standard content page containing some link anchors linked to non-standard content pages is displayed in a main frame by use of the source file stored on said source file storage unit, wherein each tour page instructs the computer having displayed itself to execute an intra-frame page control process for executing a redisplay process of redisplaying the standard content page in the main frame when meeting a predetermined condition concerning an elapse time since a certain link anchor on the standard content page has been manipulated (clicked).

Namely, each of the information providing devices according to the first mode and the second mode of the present invention has such architecture that if a certain link anchor is manipulated (clicked) on the computer of the user who desires to acquire the information, the user can be provided with the information by displaying the standard content page that is to be redisplayed when there is met the predetermined condition about the elapse time since a point of time when the anchor manipulation has been done. Accordingly, the use of the information providing device of the present invention enables the user (the browsing party of the Web page) to be provided with the information so that the user can acquired the desired piece of information without performing the complicated operations.

It should be noted that on the occasion of actualizing the information providing device according to the second mode of the present invention, the intra-frame page control process involves, if the non-standard content page displayed in the main frame is a page in which time information in a predetermined format is set, executing the redisplay process when a period of time designated in the time information elapses after displaying the non-standard content page. With a contrivance of this intra-frame page control process, it is possible to actualize the information processing device capable of redisplaying the standard content page when the period of time corresponding to a content (data size) of the non-standard content page elapses.

On the occasion of actualizing the information providing device according to the second mode of the present invention, the information providing device may further include an operation detail grasping unit for gasping details of the operation effected on the tour page and storing the details of the operation. When the information providing device according to the second mode of the present invention is actualized by adding the operation detail grasping unit thereto, it is possible to obtain the information providing device capable of easily changing a tour page layout (a sequence of the pages) to a more suitable layout on the basis of the information stored on the operation detail grasping unit.

In the case of actualizing the information providing device according to the second mode of the present invention by adding the operation detail grasping unit thereto, the operation detail grasping unit can be set as a unit for grasping the details of the operation effected on the tour page and storing the details of the operation on a user-by-user basis, and the tour page providing unit can be set as a unit for instructing the computer of each individual user to display, based on the details of the operation effected on the tour page that are stored on the operation detail grasping unit on the user-by-user basis, a tour page on which each non-standard content page browsed by the user in the past is displayed as the standard content page in the main frame thereof.

### BRIEF DESCRIPTION OF THE DRAWINGS

These and other objects and advantages of the present invention will become clear from the following description with reference to the accompanying drawings, wherein:

FIG. 1 is an explanatory diagram showing architecture and a usage mode of an information providing device according to one embodiment of the present invention;

FIG. 2 is an explanatory diagram of an index page that the information providing device according to the embodiment instructs a computer to display;

FIG. 3 is an explanatory diagram of a tour page that the information providing device according to the embodiment instructs a computer to display;

FIG. 4 is an explanatory diagram of a tour page database retained on the information providing device according to the embodiment;

FIG. 5 is an explanatory diagram of the tour page database retained on the information providing device according to the embodiment;

FIG. 6 is a flowchart of a tour page providing process executed by the information providing device according to the embodiment;

FIG. 7 is a flowchart of an intra-main-frame page control process executed by the computer having displayed the tour page;

FIG. 8 is an explanatory diagram of the tour page database retained on the information providing device according to the embodiment; and

FIG. 9 is an explanatory diagram showing an operation of the computer displaying the tour page.

### DETAILED DESCRIPTION OF THE PREFERRED EMBODIMENTS

A best mode for embodying the present invention will hereinafter be described in depth with reference to the drawings.

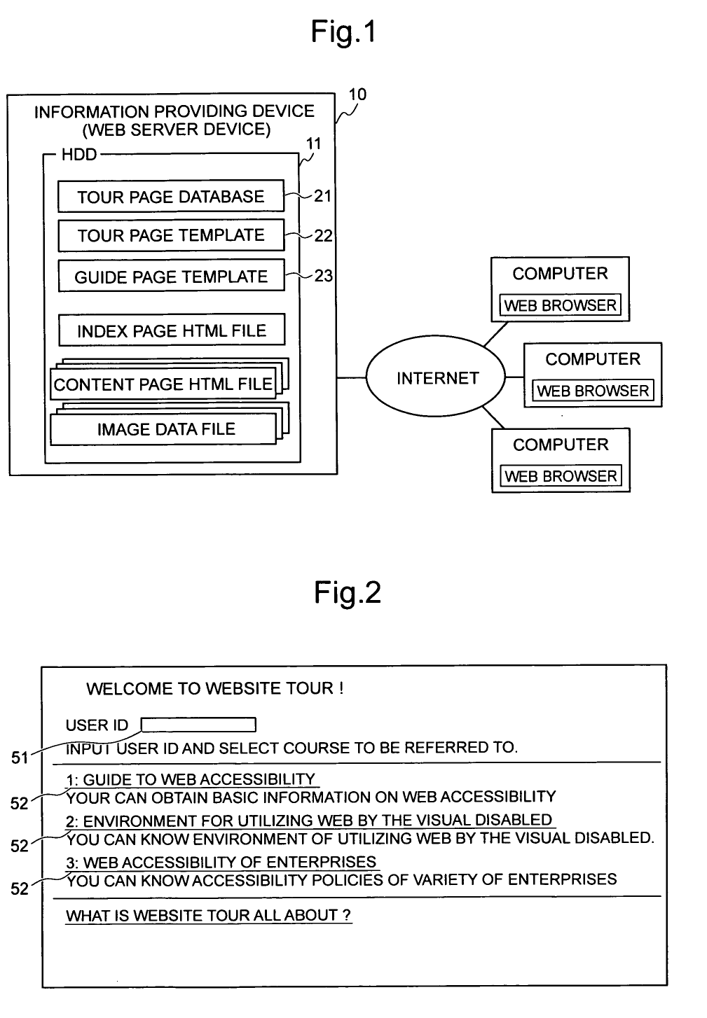

To start with, an outline of an information providing device 10 according to one embodiment of the present invention will be explained referring to FIGS. 1 through 5.

As schematically shown in FIG. 1, the information providing device 10 in the present embodiment is defined as a Web server device employed in a way that connects to the Internet in order to provide pieces of information through on Web pages. A HDD (Hard Disc Drive) 11 of the information providing device 10 is a storage device stored with a tour page database 21, a tour page template 22, a guide page template 23, an index HTML (HyperText Markup Language) file, HTML files for various categories of content pages and a variety of image data files. Note that the HDD 11 of the information providing device 10 is, though not illustrated, stored also with files of various types of programs (OS (Operating System), HTTP (HyperText Transfer Protocol) daemon, a CGI (Common Gateway Protocol) program, etc.).

The image files stored on the HDD 11 of the information providing device 10 are files utilized as elements of the various categories of Web pages provided to the users (corresponding to computers each pre-installed with Web Browser).

The content page HTML files are files that define contents of the Web pages (which will hereinafter be termed content pages) displayed on the computer (Web Browser) as elements of tour pages (of which details are given later on) provided by the information providing device 10.

It should be noted that a large proportion of the content page HTML files stored on the HDD 11 are those instructing the computer to display the content pages containing some link anchors to other content pages. Some of the content page HTML files stored on the HDD 11 are files in which byroad restricting time (which will be explained in detail later on) is embedded as a non-displayable element on the content page. To be more specific, some of the content page HTML files on the HDD 11 are the files in which the byroad restricting time (which is a value named “timer” in the form of “GuideTimer”) is embedded in the following form (HTML tags).

<FROM name = “GuideTimer”>
<INPUT TYPE = HIDDEN NAME = “timer”Value = 100>
</FORM>

The index page HTML file is a file transmitted by the information providing device 10 having received a predetermined HTTP request to a source computer (Web Browser) of this HTTP request.

The computer (Web Browser) having received the index page HTML file displays an index page structured as shown in FIG. 2. The computer, when any one of link anchors 52 on the index page is clicked in a state where a user ID (a character string in some form) is inputted to a user ID input text box 51 on the index page, transmits onto the Internet the pre-formatted HTTP request (the HTTP request that is to be received by the information providing device 10 and will hereinafter be referred to as a tour start request) containing a tour ID associated with (linked to) the clicked link anchor 52 and also the user ID inputted to the user ID input text box 51.

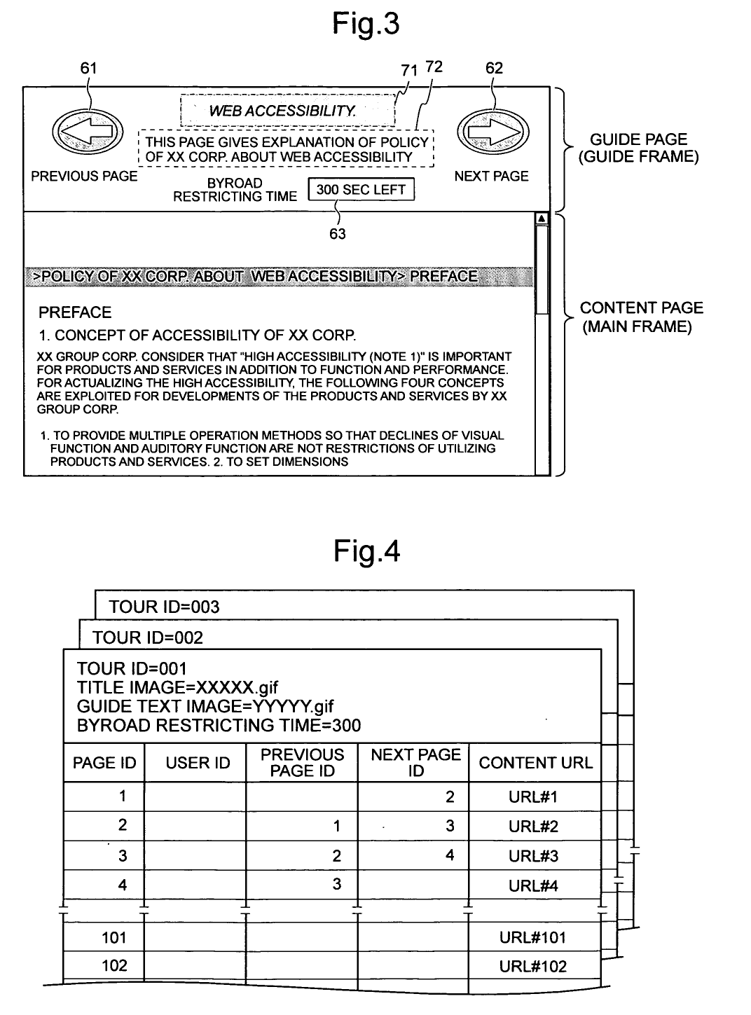

The tour page template 22 is a file utilized by the information providing device 10 in order to create a tour page HTML file for making the Web Browser display a tour page (containing a main frame for displaying a content page is displayed, and a guide frame for displaying a guide page) structured as shown in FIG. 3. The tour page template 22 is structured to enable the tour page HTML file to be created by embedding a URL (Uniform Resource Locator) of the guide page HTML file and a URL of the content page HTML file (by replacing a specified character string in the file with each URL).

The guide page HTML file of which a URL is embedded in the tour page HTML file is a file for making the Web Browser display the guide page (see FIG. 3). The guide page HTML file contains information (HTML element) for displaying an image identified with a title image file name in a field indicated by a dotted-line frame 71, information for displaying an image identified with a guide text image file name in a field indicated by a dotted-line frame 72, information for transmitting the tour page request (which is to be received by the information providing device 10 and will be described in detail later on) containing a previous page ID when pressing a previous page button 61, information for transmitting the tour page request containing a next page ID when pressing a next page button 62, and information for displaying a restricting time indicating item 63 in which the byroad restricting time is indicated. The guide page HTML file contains a script for instructing the computer to execute an intra-main-frame control process (which will hereinafter be explained in depth).

The guide page template 23 (see FIG. 1) stored on the HDD 11 of the information providing device 10 is a file structured so that the guide page HTML file can be created by entering therein values of a previous page ID, a next page ID, a title image file name, a guide text image file name and a byroad restricting time. Note that the guide page template 23 is structured such that the guide page HTML file for displaying the guide page containing neither the previous page button 61 nor the next page button 62 is acquired by entering “null” in the fields of the previous page ID and the next page ID. The information providing device 10 according to the present embodiment is the device, wherein the guide page template 23, the rout page template 22, the content HTML file and the image data file generically correspond to a source file in the information providing device of the present invention, and a module related to the tour page providing process, which will be described later on, corresponds to a Web page providing unit.

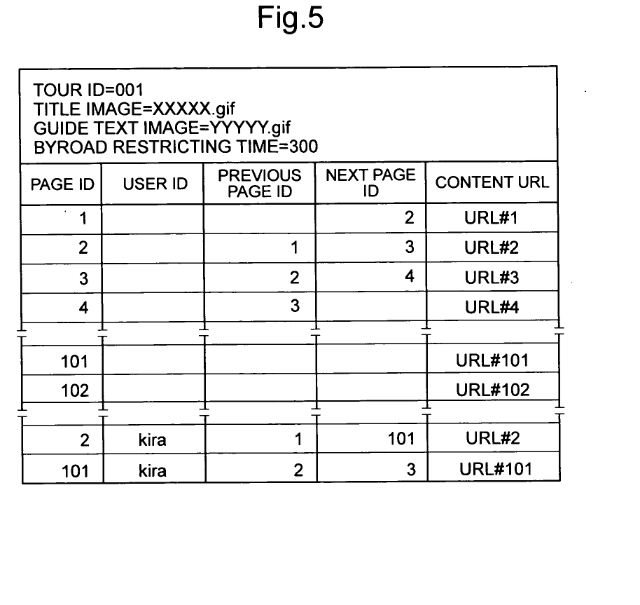

The tour page database 21 is a database taking a status as schematically shown in FIG. 4 immediately after starting the operation of the information providing device 10, and taking a status as schematically shown in FIG. 5 after the start of the operation of the information providing device 10.

To be specific, the tour page database 21 is a database capable of storing, with respect to each of a plurality of tour IDs, a title image file name (“XXXX.gif” in FIG. 4), a guide text image file name (“YYYYY.gif” in FIG. 4), byroad restricting time (300 sec in FIG. 4) and a plurality of display page records (each record consists of data entered in the fields of a page ID, a user ID, a previous ID, a next page ID, a content URL). The tour page database 21, when in a status of being stored with none of the display page records with the user IDs set therein, is a database that starts being utilized (see FIG. 4). The tour page database 21 is a database (see FIG. 5) to which a display page record with the user ID set therein is added after starting the operation of the information providing device 10.

On the premise of what has been discussed so far, the architecture and the operation of the present information providing device 10 will be described more specifically.

As already explained, the information providing device 10 enables the computer (Web Browser) having an access to the device 10 itself to display the index page (FIG. 2). The index page is defined as a Web page enabling the computer displaying this index page to transmit the tour start request containing the tour ID and the user ID onto the Internet.

The information providing device 10 having received the tour start request starts a process (which will hereinafter be termed a session management process) of handling the tour page request, a browsing page notification request, etc. which will be sent afterward from the source computer (that will hereinafter be called a communication target computer) of the tour start request in a way that associates these requests with the user ID and the tour ID contained in the tour start request. It should be noted that the tour page request is, as already explained, defined as a HTTP request containing the page ID (the previous page ID or the next page ID) which is sent by the computer (Web Browser) displaying the tour page (see FIG. 3) when the previous page button 61 or the next page button 62 is clicked on. It also should be noted that the browsing page notification request is defined as a HTTP request (of which the details will be given later on) sent by the computer displaying the tour page when displaying a different content page in the main frame.

The information providing device 10 having received the tour start request and having started the session management process, executes a tour page providing process as a process for instructing the communication target computer to display the tour page in a way that sets values, as parameters of this tour page providing process, of a target page ID, a target tour ID and a target user ID respectively to “1” and associates these parameters with the tour ID and the user ID contained in the tour start request.

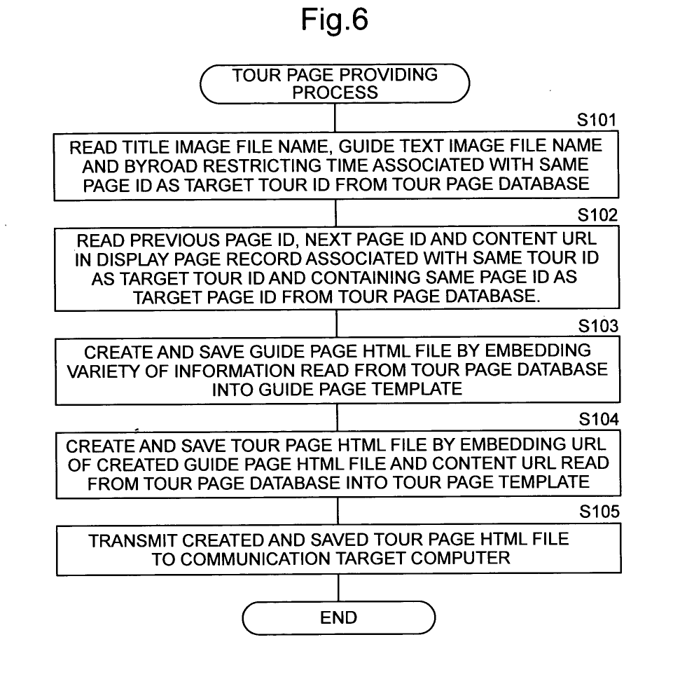

A content of the tour page processing process executed by the information providing device 10 will be explained with reference to FIG. 6. Note that the tour page providing process is the process executed by the information providing device 10 having received the tour page request, wherein the target tour ID and the target user ID are associated respectively with the tour ID and the user ID (managed by the session management process) contained in the tour page request, and the target page ID is associated with the page ID (previous page ID or the next page ID) contained in the tour page request.

As shown in the Figure, the information providing device 10 having initiated the tour page providing process, to begin with, reads from the tour page database 21 (see FIGS. 4 and 5) a title image file name, a guide text image file name and byroad restricting time that are associated with the tour ID corresponding to the target tour ID (step S101).

Subsequently, the information providing device 10 reads from the tour page database 21 a previous page ID, a next page ID and a content URL within the display page record of which the tour ID is associated with the target ID and the page ID is coincident (associated) with the target page ID (step S102). Note that the process in step S102 involves, when the tour page database 21 is stored with the display page record of which the page ID and the user ID are coincident (associated) with the target page ID and the target user ID, reading the previous page ID, the next page ID and the content URL within the display page record. To be specific, the process in step S102 involves reading “1”, “3” and “URL#2” respectively as values of the previous page ID, the next page ID and the content URL, when values of the target tour ID, the target user ID and the target page ID are “001”, “kira” and “2” and when the contents of the tour page database 21 are those shown in FIG. 4. This process in step S102 also involves reading “1”, “101” and “URL#2” respectively as values of the previous page ID, the next page ID and the content URL, when values of the target tour ID, the target user ID and the target page ID are “001”, “kira” and “2” and when the contents of the tour page database 21 are those shown in FIG. 5.

The information providing device 10 organizes, into the guide page template 23, the title image file name, the guide text image file name, the previous page ID, the next page ID and the byroad restricting time that have been read from the tour page database 21, thereby creating the guide page HTML file and saving this file on the HDD 11 (step S103).

The information providing device 10 organizes, into the tour page template 22, the URL of the thus-created guide page HTML file and the content URL read from the tour page database 21, thereby creating the tour page HTML file and storing this file on the HDD 11 (step S104). The information providing device 10, after sending the thus-created-and-stored tour page HTML file to the communication target computer (step S105), terminates the tour page providing process.

Given next is an explanation of a content of an intra-main-frame page control process executed by the communication target computer having received the tour page HTML file. Note that a content page displayed for the first time in the main frame is called a standard content page in the following discussion.

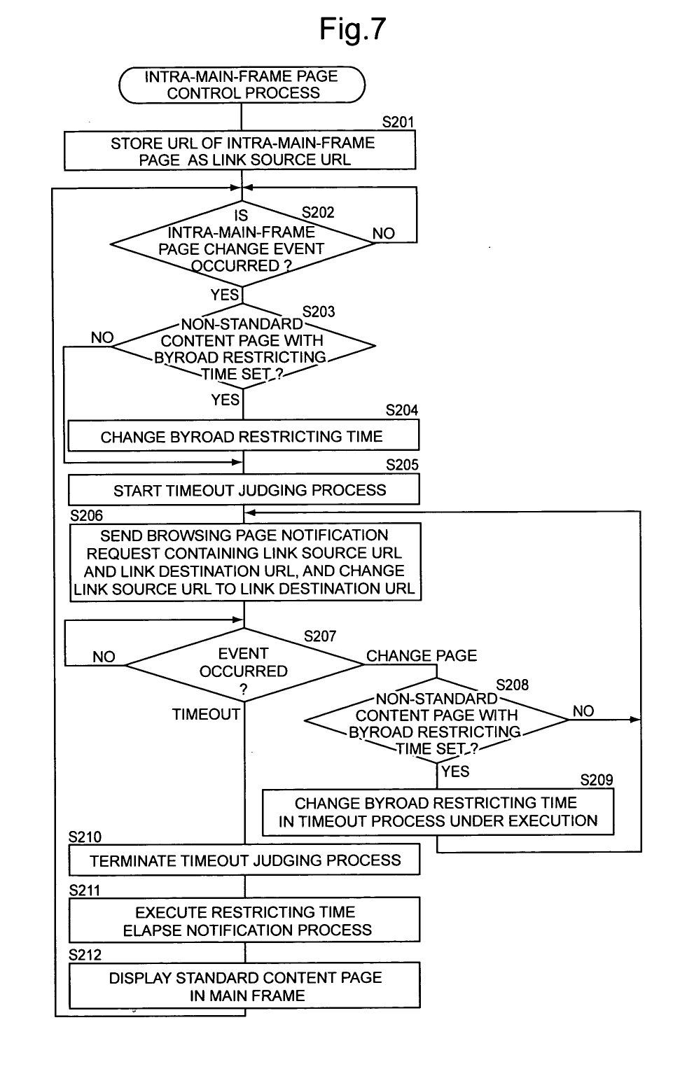

As shown in FIG. 7, the communication target computer having started the intra-main-frame page control process (of which the content is defined by the script of the guide page HTML file), at first stores the URL of the standard content page (that is the page in the main frame in FIG. 7) displayed in the main frame as a link source URL (step S201). The communication target computer starts a process (step S202) of monitoring an occurrence of an intra-main-frame page change event. The intra-main-frame page change event herein connotes an event such as [the content page with its URL different from the link source URL is displayed in the main frame].

When detecting that the intra-main-frame page change event occurs (step S202; YES), the communication target computer judges whether or not the byroad restricting time is set in the content page (which is a content page displayed afresh in the main frame and will hereinafter be called a non-standard content page) displayed in the main frame at that point of time (step S203).

When the byroad restricting time is set in the non-standard content page displayed afresh in the main frame (step S203; YES), the communication target computer executes a process (step S204) of changing the byroad restricting time defined as a parameter in a timeout judging process to the byroad restricting time set in the non-standard content page. The communication target computer initiates the timeout judging process as a process of displaying the byroad resting time in the restricting time display item 63 (see FIG. 3) in a way that decrements the byroad restricting time by “1” with every 1-sec elapse, and also as a process of monitoring that the byroad restricting time comes to “0” (which will hereinafter be expressed such as [an occurrence of timeout]) (step S205).

While on the other hand, when the byroad restricting time is not set in the non-standard content page displayed in the main frame (step S203; NO), the communication target computer starts the timeout judging process without changing the byroad restricting time (step S205).

The communication target computer having started the timeout judging process executes a process (step S206) of changing the link source URL to a link destination URL after transmitting onto the Internet the browsing page notification request containing the link source URL and a URL of the non-standard content page (which will hereinafter be referred to as the link destination URL) displayed afresh in the main frame.

The browsing page notification request sent in the process in step S206 is a HTTP request that is to be received by the information providing device 10. The information providing device 10 having received the browsing page notification request operates as follows. Note that the tour ID and the user ID (which are managed by the session management process) associated with the browsing page notification request will be respectively called an associated tour ID and an associated user ID in the following discussion.

The information proving device 10 having received the browsing page notification request at first searches the tour page database 21 (see FIGS. 4 and 5) for a display page record containing the content URL coincident with the link destination URL contained in the browsing page notification request, the user name (user ID) coincident with the associated user name (associated user ID) and the tour ID coincident with the associated tour ID.

When this display page record can be retrieved from the tour page database 21, it follows that a content page specified by the link destination URL is displayable by manipulating the previous page button 61 and the next page button 62. Therefore, in this case, the information providing device 10 terminates the process for the browsing page notification request.

While on the other hand, when the display page record that meets the conditions given above can not be retrieved, the information providing device 10 executes a process of reading from the tour database 21 and storing a display page record (with no value set in the user ID) containing the content URL coincident with the link destination URL contained in the browsing page notification request, and the tour ID coincident with the associated tour ID, and further storing the page ID contained therein as a next page ID for an existing page.

The information providing device 10 searches the tour page database 21 for a display page record containing the content URL coincident with the link source URL contained in the browsing page notification request, the user name coincident with the associated user name and the tour ID coincident with the associated tour ID.

When this display page record can be retrieved, the information providing device 10 reads a previous page ID and a next page ID in this display page record, and stores these page IDs as a previous ID for a new page and a next page ID for the new page. The information providing device 10 executes a process of changing the next page ID in the display page record to the next page ID for the existing page. The information providing device 10 also executes a process of adding to the tour page database 21 a display page record of which the associated user ID, the previous page ID for the new page and the next page ID for the new page are mapped (set) respectively to the user ID, the previous page ID and the next page ID in the already-read-out display page record of the page specified by the link destination URL. Then, the information providing device 10 terminates the process for the browsing page notification request.

Whereas if incapable of searching for the display page record that meets the conditions given above, the information providing device 10 reads from the tour page database 21 a display page record (with no value set in the user ID) containing the content URL coincident with the link source URL contained in the browsing page notification request, the tour ID coincident with the associated tour ID. The information providing device 10, after storing the previous page ID and the next page ID in the readout display page record as the previous page ID for the new page and the next page ID for the new page, executes a process of adding to the tour page database 21 a display page record (with the user ID set and the next page ID changed) of which the user ID and the next page ID are mapped (set) respectively to the associated user ID and the next page ID for the existing page and the next page ID in the already-read-out display page record of the page specified by the link destination URL. The information providing device 10 also executes a process of adding to the tour page database 21 a display page record of which the associated user ID, the previous page ID for the new page and the next page ID for the new page are mapped (set) respectively to the user ID, the previous page ID and the next page ID in the already-read-out display page record of the page specified by the link destination URL. Then, the information providing device 10 terminates the process for the browsing page notification request.

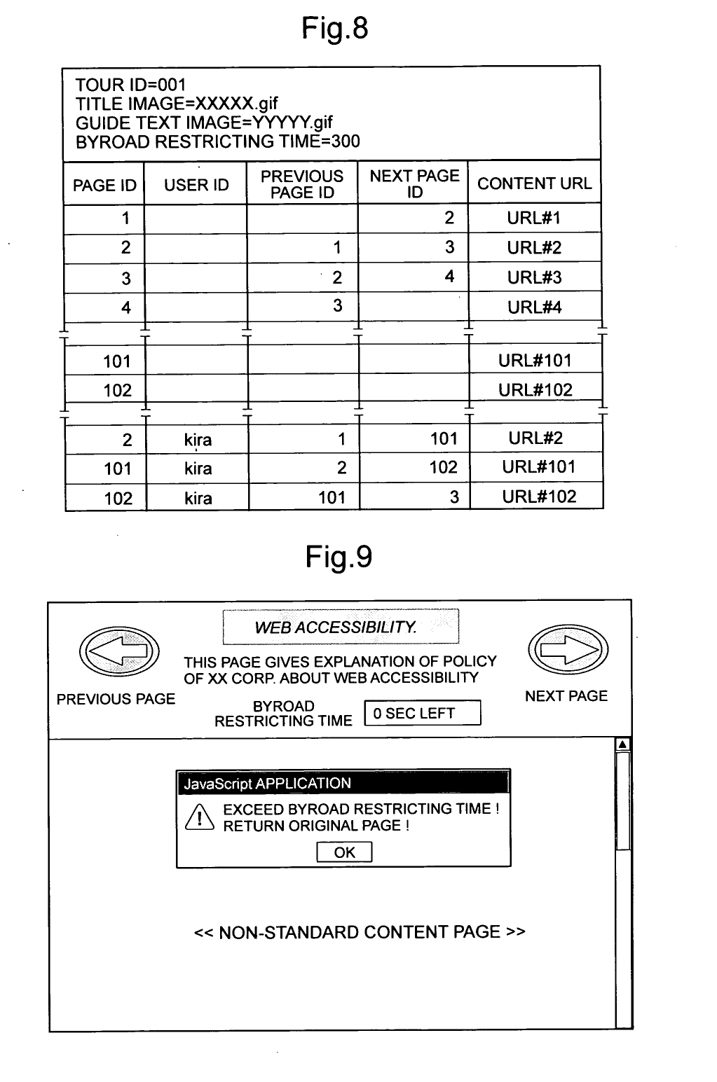

In short, when receiving the browsing page notification request (transmitted by the intra-main-frame page control process as a result of clicking the link anchor on the content page specified by URL#2) in which the associated tour ID is “001”, the associated user ID is “kira”, and, when the tour page database 21 is in the status as shown in FIG. 4, the link source URL is URL#2, and the link destination URL is URL#101, the information providing device 10 changes the contents of the tour page database 21 to those shown in FIG. 5. When receiving the browsing page notification request (transmitted by the intra-main-frame page control process as a result of clicking (manipulating) the link anchor on the content page specified by URL#101) in which the associated tour ID is “001”, the associated user ID is “kira”, and, when the tour page database 21 is in the status as shown in FIG. 5, the link source URL is URL#101, and the link destination URL is URL#102, the information providing device 10 changes the contents of the tour page database 21 to those shown in FIG. 8.

Referring back to FIG. 7, the discussion on the operation of the communication target computer having received the tour page HTML file (the content of the intra-main-frame page control process) will continuously proceed.

The communication target computer having finished transmitting the browsing page notification request starts a process (step S207) of monitoring that the timeout occurs (the byroad restricting time comes to “0”) and that the intra-main-frame page change event occurs.

The communication target computer, when detecting the intra-main-frame page change event occurs (step S207; page change), judges whether or not the byroad restricting time is set in the non-standard content page displayed in the main frame at that point of time (step S208). When the byroad restricting time is set therein (step S208; YES), the communication target computer starts a process subsequent to step S206 after changing the byroad restricting time in the timeout judging process under the execution to the byroad restricting time set in the non-standard content page (step S209). Whereas if the byroad restricting time is not set in the non-standard content page displayed in the main frame (step S208; NO), the communication target computer starts the process subsequent to step S206 without changing the byroad restricting time.

The communication target computer, when the timeout occurs (step S207; YES), terminates the timeout judging process (step S210) and thereafter executes a restricting time elapse notification process (step S211). The restricting time elapse notification process is, as shown in FIG. 9, a process of displaying on the tour page a dialog box for notifying the user that the standard content page is redisplayed in the main frame, and is also a process terminated when an OK button in the dialog box is pressed.

The communication target computer having finished the standby time (restricting time) elapse notification process executes a process (step S212) for displaying the standard content page in the main frame, and thereafter restarts the processes subsequent to step S202.

As obvious from the discussion given above, the information providing device 10 according to the present embodiment instructs the computer (Web Browser) to display the tour page. This tour page is the Web page in which the standard content page is redisplayed in the main frame when the non-standard content page is displayed in the main frame by the user (who is a browsing party of the tour page) clicking the link anchor on the standard content page displayed in the main frame, when other non-standard content page is displayed in the main frame by clicking the link anchor on the non-standard content page, and when the predetermined conditions are met (such as elapsing of the byroad restricting time set in the guide page, and elapsing of the byroad restricting time reset with the byroad restricting time set in the non-standard content page).

Accordingly, the use of the information providing device 10 enables the each individual user to be provided with the information in such a mode that the standard content page is automatically redisplayed (so that the user has no necessity of performing the intricate operations for redisplaying the standard content page).

The tour page that the information providing device 10 instructs the computer to display is a page, wherein when the byroad restricting time is set in the non-standard content page referred to by the user, the standard content page is redisplayed after the byroad restricting time has elapsed. It therefore follows that the use of the information providing device 10 enables the information to be provided to the user with such a scheme that the time till the standard content page is redisplayed is determined corresponding to a content of the non-standard content page referred to by the user (for example, a data size shown on the non-standard content page referred to by the user is proportional to the time till the standard content page is redisplayed).

The information providing device 10, based on a result of grasping details (the link source URL and the link destination URL transferred as elements of the browsing page notification request) of the user's operation on the tour page (content page), provides each individual user with the tour page in which the respective non-standard content page browsed by the user in the past is displayed as the standard content page in the main frame. The information providing device 10 can be therefore said to be the device configured to automatically change the display sequence of the tour pages (content pages) to a sequence suited to the user.

### MODIFIED EXAMPLE

The information providing device 10 can be modified in a variety of forms. The information providing device 10 changes the contents of the tour page database 21 in the midst of the user's browsing the tour page. The information providing device 10 may, however, be modified such that the user, after having completely finished browsing the tour page, is queried about whether a layout of the tour page (the display sequence of the content page) is changed or not, and the contents of the tour page database 21 are changed when the user indicates a change in the layout of the tour page. In the information providing device 10, the HDD 11 is stored with the content of the browsing page notification request. The information providing device 10 can be, however, modified not to automatically change the contents of the tour page database 21. In other words, the information providing device 10 may also be modified so that the HDD 11 is stored with the content of the browsing page notification request as information referred to by the administrator of the information providing device 10 in order to change the layout of the tour page.

The information providing device 10 instructs the computer to display the tour page containing the link anchors (the previous page button 61 and the next page button 62) for displaying other tour pages. The information providing device 10 may also be modified so as to display the Web page with the previous page button 61 and the next page button 62 removed from the tour page.

1. An information providing device comprising:
a source file storage unit stored with a variety of source files related to various categories of Web pages; and
a Web page providing unit enabling a computer capable of Web-browsing to display a standard content page containing some link anchors linked to non-standard content pages or to display a non-standard content page containing some link anchors linked to other non-standard content pages by use of the source files stored on said source file storage unit, and instructing said computer having displayed the standard content page to execute a process of redisplaying the standard content page when meeting a predetermined condition concerning an elapse time since a certain link anchor on the standard content page has been manipulated.

2. An information providing device comprising:
a source file storage unit stored with a variety of source files related to various categories of Web pages; and
a tour page providing unit for instructing a computer capable of Web-browsing to display various categories of tour pages in each of which a guide page containing link anchors linked to other tour pages is displayed in a guide frame, and a standard content page containing some link anchors linked to non-standard content pages is displayed in a main frame by use of the source files stored on said source file storage unit,
wherein each tour page instructs the computer having displayed itself to execute an intra-frame page control process for executing a redisplay process of redisplaying the standard content page in the main frame when meeting a predetermined condition concerning an elapse time since a certain link anchor on the standard content page has been manipulated.

3. An information providing device according to claim 2, wherein the intra-frame page control process involves, if the non-standard content page displayed in the main frame is a page in which time information in a predetermined format is set, executing the redisplay process when a period of time designated in the time information elapses after displaying the non-standard content page.

4. An information providing device according to claim 1, further comprising operation detail grasping unit for gasping details of the operation effected on the tour pagea and storing the details of the operation.

5. An information providing device according to claim 1, wherein said operation detail grasping unit is unit for grasping the details of the operation effected on the tour pages and storing the details of the operation on a user-by-user basis, and
said tour page providing unit is unit for instructing the computer of each individual user to display, based on the details of the operation effected on the tour page that are stored on said operation detail grasping unit on the user-by-user basis, a tour page on which each non-standard content page browsed by the user in the past is displayed as the standard content page in the main frame thereof.

6. An information providing program retaining a variety of source files related to various categories of Web pages and executed on a computer employed in a way that connects the Internet, said program making said computer capable of Web-browsing to function as a device comprising:
a Web page providing unit enabling said computer to display a standard content page containing some link anchors linked to non-standard content pages or to display a non-standard content page containing some link anchors linked to other non-standard content pages by use of the source files, and instructing said computer having displayed the standard content page to execute a process of redisplaying the standard content page when meeting a predetermined condition concerning an elapse time since a certain link anchor on the standard content page has been manipulated.

7. An information providing program retaining a variety of source files related to various categories of Web pages and executed on a computer employed in a way that connects the Internet, said program making said computer capable of Web-browsing to function as a device comprising:
a tour page providing unit for instructing a computer capable of Web-browsing to display various categories of tour pages in each of which a guide page containing link anchors linked to other tour pages is displayed in a guide frame, and a standard content page containing some link anchors linked to non-standard content pages is displayed in a main frame by use of the source files stored on said source file storage unit,
wherein each tour page instructs the computer having displayed itself to execute an intra-frame page control process for executing a redisplay process of redisplaying the standard content page in the main frame when meeting a predetermined condition concerning an elapse time since a certain link anchor on the standard content page has been manipulated.
